(19) United States
(12) Patent Application Publication
(10) Pub. No.: US 2012/0065829 A1
(43) Pub. Date: Mar. 15, 2012

(54) Wall-following Moving Device

(76) Inventors: Jyh-Cheng Yu, Kaoshiung (TW); Jason Yan, Kaoshiung (TW)

(21) Appl. No.: 12/882,214

(22) Filed: Sep. 15, 2010

(51) Int. Cl. G05D 1/03

(52) U.S. Cl. 701/23

(57) ABSTRACT

A wall-following moving device consists of a base; a determining drive unit; multiple collision sensing units; two signal transceiver units arranged at the same lateral side of the base parallel to the moving direction of the base for synchronously transmitting and receiving specific signals, and being electrically connected to the determining drive unit; and a moving element mounted to the base and controlled by the determining drive unit to perform various movements. The determining drive unit compares two reflected signals from a wall received separately by two signal transceiver units, and uses the intensity difference of the signals as a basis to control the moving element to orientate the robot parallel to the wall. By an intricate coordination of the collision sensing units, two signal transceiver units, determining drive unit, and the moving element, the distance between the robot and a wall can be precisely determined and controlled.

### BACKGROUND OF THE INVENTION

1. Field of the Invention

The present invention relates to a wall-following moving device, which is mounted on a robot for controlling the robot to move parallelly along an obstacle, such as a wall.

2. Description of the Prior Arts

The application technique of an automated product, such as a mobile robot, for domestic chores has gradually become mature. The mobile robot, such as a cleaning robot or a security robot, when being used indoor, is often required to move along an obstacle, such as a wall, in a constant distance so as to clean corners, locate entrances and exits, or search for a charging base.

According to most of the existing techniques for controlling the robot to move along a wall, when the robot collides against the wall, a control integrated circuit (IC) calculates to thereby drive the robot to move backward, adjust to a correct moving direction, and then move forward again. For the robot to perform movements in the above-described manner, multiple collision sensing units must be installed on the robot to enable collision sensing of the robot with the wall at various angles, so as to accurately control the robot's moving direction.

Please refer to FIG. 10. A conventional wall-following robot 90 can be further provided with a collision protection mechanism, such as a protection bumper 91 mounted around the robot 90. When the protection bumper 91 collides with an obstacle, the collision sensing units are triggered to cause a driving device to turn. However, such collision protection mechanism is not able to measure the distance between the robot 90 and the obstacle when the robot 90 is away from the obstacle. As a result, the robot 90 has to repeatedly collide with the obstacle in a zigzag path to move forward along the obstacle. In this manner, there would be dead corners that could not be accessed and cleaned by the robot 90.

Moreover, in the existing techniques, infrared sensors are used to measure the distance between the robot and the wall. When using the signal intensity of a reflected infrared beam to measure the distance between the robot and the wall, the accuracy of the measured distance is easily affected by many factors, such as the color of the wall surface, the glossy or diffusive surface of the wall, and the angles of reflection of the infrared beam from the wall. Certain design arranges an optical emitter and a photon detector in a specific angular position, and uses the size of the overlap area of the field of emission of the emitter and the field of view of the detector to estimate the distance between the robot and the obstacle. However, the size of the overlap area is determined by the intensity of the reflected signal that will still be affected by the surface characteristics of the obstacle to adversely influence the accuracy of the measured distance. That is, while the prior art enables the robot to move parallelly along various types of wall, it does not ensure that a constant distance can be maintained between the robot and the wall.

This invention aims to overcome the above problems of a conventional wall-following robot by developing a novel system that can precisely control the distance between a robot and a wall when the robot moves along the wall.

### SUMMARY OF THE INVENTION

A primary object of the present invention is to provide an improved wall-following moving device for accurately control a robot to move along and parallel with an obstacle.

To achieve the above and other objects, the wall-following moving device according to the present invention includes:

a base;

a determining drive unit;

multiple collision sensing units mounted to the front end of the base;

two signal transceiver units arranged at the same lateral side of the base into a line parallel with the moving direction of the base for synchronously transmitting and receiving specific signals, and being electrically connected to the determining drive unit; and

a moving element mounted to the base and electrically connected to and accordingly driven by the determining drive unit to perform various movements.

The determining drive unit compares two signals reflected back from a wall and respectively received by the two signal transceiver units, and uses the intensity difference between the received signals as a basis to control the moving element to orientate the robot parallel to an obstacle. Triggered by the collision sensing units, the distance between the moving device and a wall can be precisely determined and controlled by an intricate coordination of the two signal transceiver units, the determining drive unit, and the moving element. The control error of the distance between the robot and an obstacle due to the variation of reflected signal intensity for different surface characteristics of the obstacle can be thus avoided.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic plan view showing the structure of a wall-following moving device according to a preferred embodiment of the present invention;

FIG. 2 is an operational view showing the manner in which the wall-following moving device of the present invention operates;

FIG. 3 is an operational view showing the wall-following moving device of the present invention in the state of moving parallel to an obstacle;

FIGS. 4 to 6 are operational views showing different steps in which the wall-following moving device of the present invention automatically adjusts its moving direction to be parallel with an obstacle;

FIG. 7 is an operational view showing how the wall-following moving device of the present invention operates to finally move parallelly along an obstacle;

FIG. 8 is an operational view illustrating an example of distance calculation by the wall-following moving device of the present invention;

FIG. 9 is an operational view showing how the wall-following moving device of the present invention operates to finally move forward with a constant distance kept between the device and an obstacle; and

FIG. 10 is an operational view of a conventional wall-following robot using collision sensors, which actually moves in a zigzag path.

### DETAILED DESCRIPTION OF THE PREFERRED EMBODIMENTS

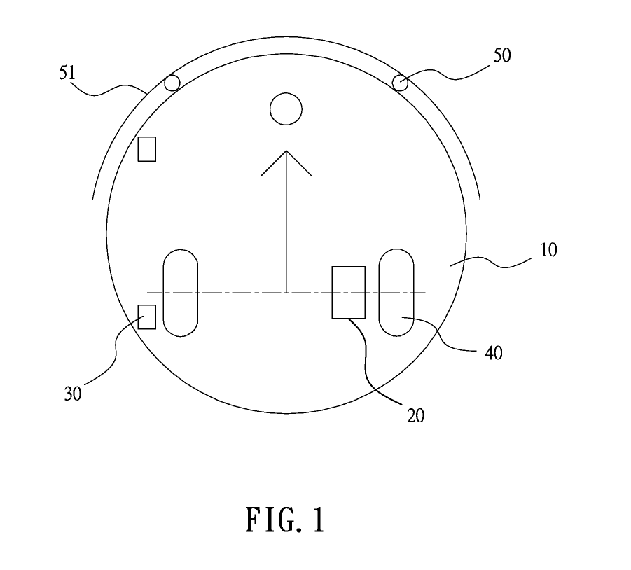

Please refer to FIG. 1 that is a schematic plan view showing the structure of a wall-following moving device according to a preferred embodiment of the present invention. The wall-following moving device of the present invention can be mounted to a bottom of a robot to control the robot moving indoors to move along an obstacle, such as a wall, with a constant distance from the obstacle, so that a cleaning robot, for example, can clean wall corners and perform other movements. As shown, the wall-following moving device according to a preferred embodiment of the present invention includes a base 10, a determining drive unit 20, two signal transceiver units 30, a moving element 40, and multiple collision sensing units 50. The base 10 is mounted to a bottom of a robot and may be circular.

The determining drive unit 20 is mounted on the base 10 and is an electronic device with multiple encoders connected to the moving element so as to serve as a motion central control unit. When a signal is received, the determining drive unit 20 can calculate, determine, and select a moving command for the wall-following moving device to move forward or backward by a specified distance or turn to different direction by a specified angle. The determining drive unit 20 has been widely applied in mobile robot movement control and is a technical means known by those having ordinary skill in the art. Since the technique related to the determining drive unit 20 is not an inventive characteristic of the present invention, it is not discussed in details herein. Therefore, only its function in the present invention is described.

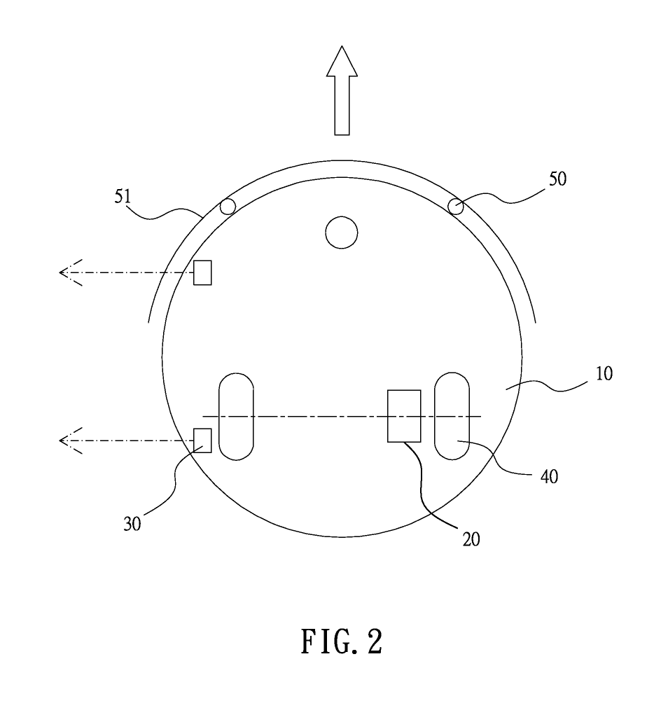

Please further refer to FIG. 2. The two signal transceiver units 30 are adapted to synchronously transmit and receive specific signals, such as infrared, are arranged at the same lateral side of the base 10 and are spaced out from each other, such that a line extending through the two signal transceiver units 30 is parallel with the moving direction of the base 10. The signal transceiver units 30 each has a transmission and a receiving terminal being perpendicular to the moving direction of the base 10 and oriented to an outer side of the base 10, so that two signals can be sideward transmitted out from the transmission terminals relative to the base 10. When the transmitted specific signals reach an obstacle, they are reflected back and separately received by the receiving terminals of the two signal transceiver units 30. The signal transceiver units 30 are electrically connected to the determining drive unit 20, so that intensity of each of the two received signals can be sent from the signal transceiver units 30 to the determining drive unit 20. The signals transmitted and received by the signal transceiver units 30 can be otherwise ultrasonic signals or any other signals that will be reflected back when in contact with an obstacle. Moreover, to enhance accuracy in detecting the moving direction of the base, at least one signal transceiver unit 30 can be further increased.

The moving element 40 is mounted to the base 10. In the illustrated embodiment, the moving element 40 includes two wheels, which are driven to rotate by two separate motors and symmetrically spaced at the opposite lateral sides of the base 10; and one or more swivel wheels may be applied to serve as auxiliary supports. The motors are electrically connected to and can therefore be driven by the determining drive unit 20 to perform various movements, such as moving forward, backward, etc. With these operations, the motors can individually control the wheels of the moving element 40 to rotate forward or backward and thereby move the base 10 straight forward or backward, respectively. Or, the two wheels can also be driven by the motors to rotate at different speeds in response to a required turning radius, so that the base 10 can be turned about any point on an axial line of two driving wheels.

The collision sensing units 50 are arranged along the front of the base 10. A protection bumper 51 can be further attached to the collision sensing units 50 to serve as a protector and a collision transducer. The collision sensing units 50 are electrically connected to the determining drive unit 20. At collision, the collision sensing units can transmit an electric signal to the determining drive unit 20 for the latter to determine an optimal movement and to drive the moving element 40. With the collision sensing units 50, whenever the wall-following moving device of the present invention comes into contact with a front obstacle during moving, a signal can be transmitted to the determining drive unit 20 for the same to determine a corresponding movement command, so that the moving element 40 can do successive movements of moving backward, reorienting, and moving forward again. Since the collision sensing unit 50 is currently a widely applied technical means, and the arrangement and operation thereof are known among those having ordinary skill in the art, it is not discussed in details herein.

When the wall-following moving device of the present invention operates, the signal transceiver units 30 provided at one lateral side thereof keep transmitting infrared signals or ultrasonic signals sideward to detect an obstacle, such as a wall, and receiving the signals reflected back from the wall. Electronic messages obtained from the detection signals are sent by the transceiver units 30 to the determining drive unit 20, at where the specific signals received by the two signal transceiver units 30 are compared to determine a relative ratio of the signal intensity received separately by the two signal transceiver units 30.

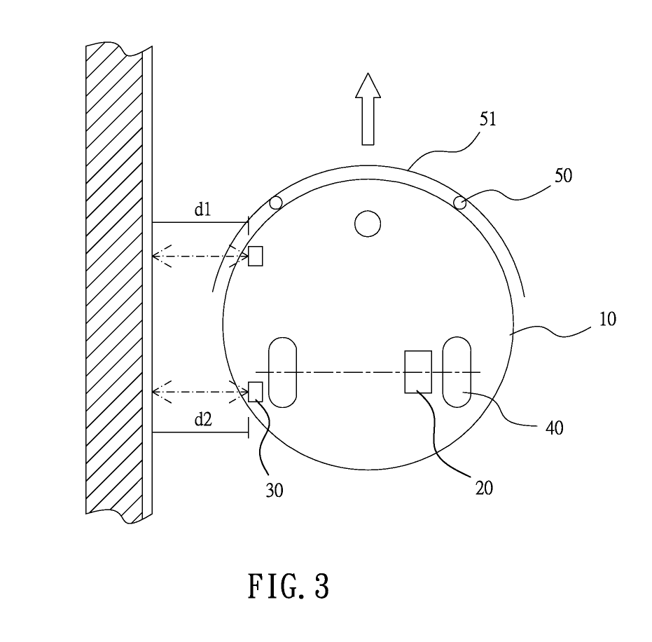

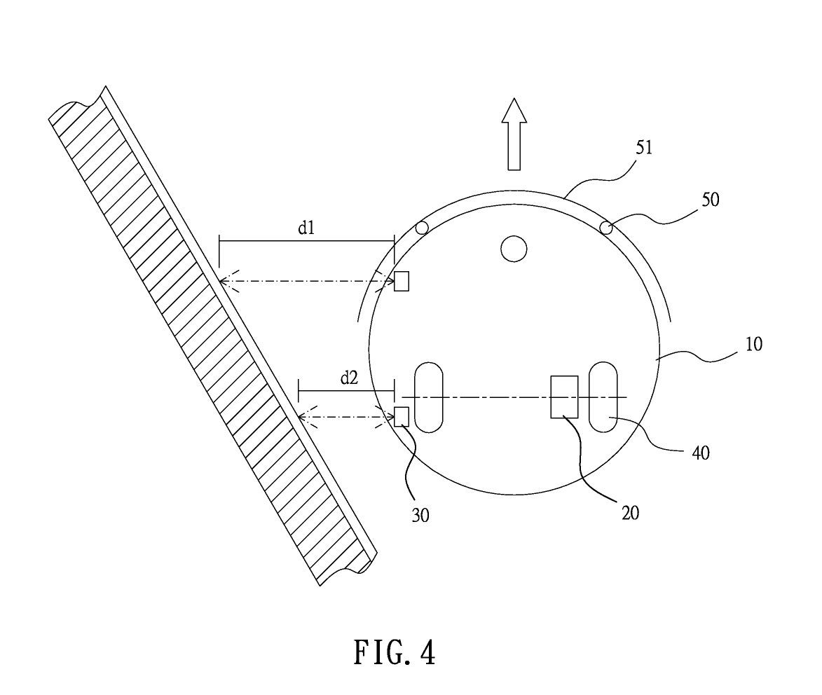

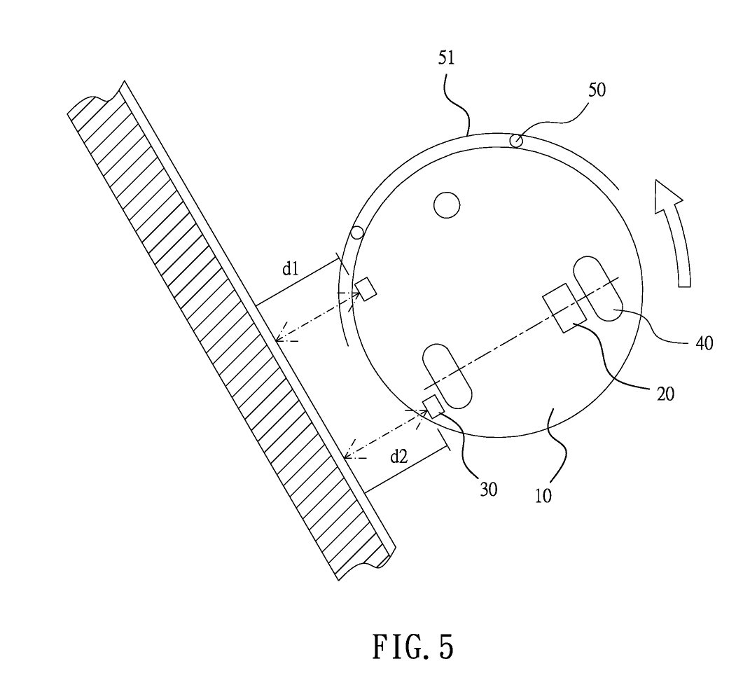

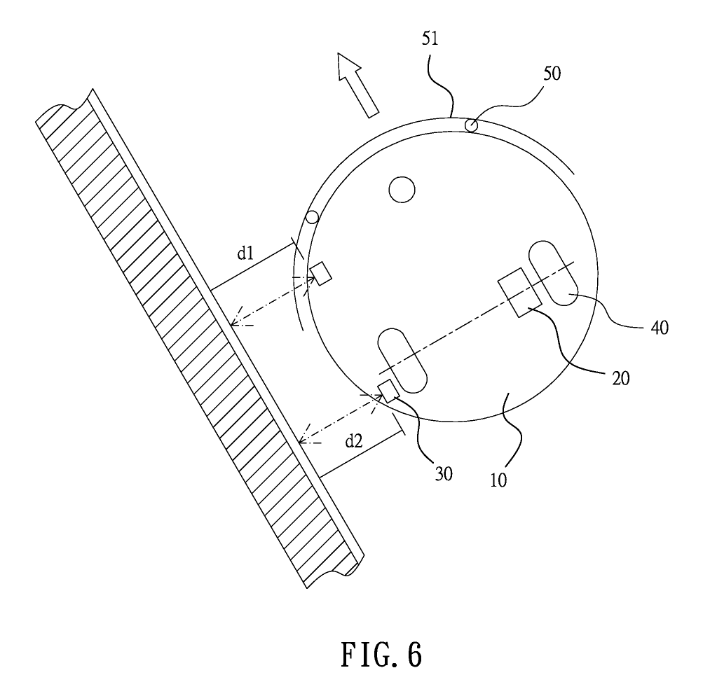

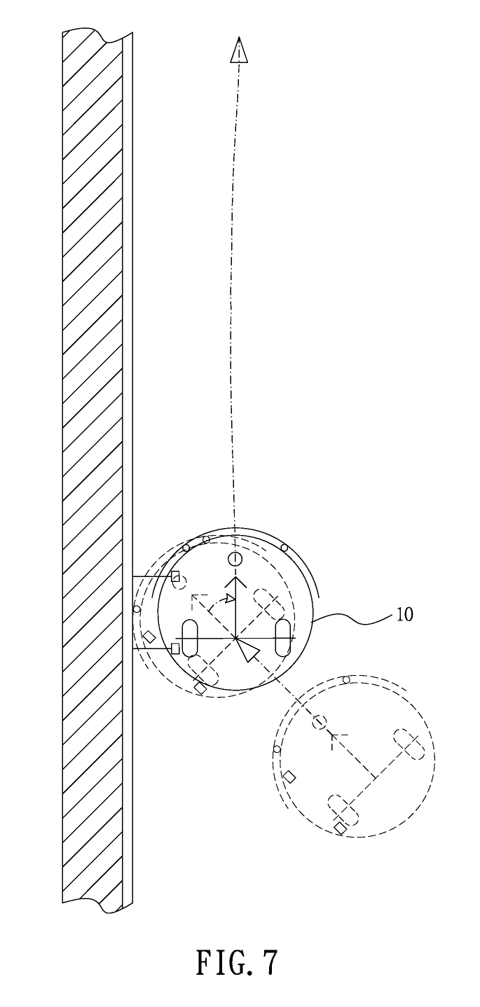

Please refer to FIG. 3. When the base 10 moves in a direction parallel to the wall, a distance d1 between the first signal transceiver unit 30 and the wall and a distance d2 between the second signal transceiver unit 30 and the wall are the same, and the specific signals separately received by the two signal transceiver units 30 would have the same signal intensity. After determining that the two received specific signal intensity are the same, the base 10 is driven to keep moving forward parallel to the wall. Please further refer to FIGS. 4 to 6. In the case the base 10 moves in a direction not parallel to the wall, the distance d1 and the distance d2 are different and the specific signals received separately by the two signal transceiver units 30 would be different in signal intensity. When the determining drive unit 20 reads the electronic messages sent thereto and determines the relative ratio of the intensity of the two received specific signals, it further calculates based on the relative ratio of signal intensity to obtain a turning angle required to adjust the moving direction of the base 10. Then, the determining drive unit 20 sends corresponding movement commands to drive the moving element 40 to adjust the moving direction until the specific signals received separately by the two signal transceiver units 30 have the same signal intensity, that is, the base 10 has been adjusted to the moving direction parallel with the wall. At this point, the wheels can be driven to rotate forward. Meanwhile, the two signal transceiver units 30 keep transmitting infrared or ultrasonic signals to detect the difference between the two distances d1 and d2 for continuously adjusting the rotating speed of the two wheels, so that the robot can keep moving parallel to the wall, as shown in FIG. 7.

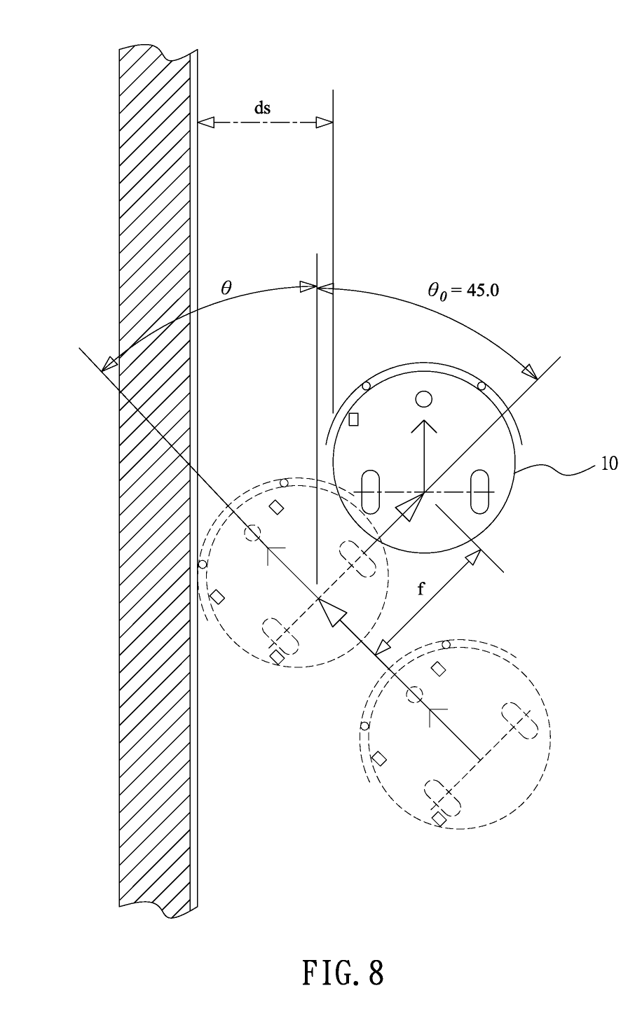

FIG. 8 illustrates an example of distance calculation by the wall-following moving device of the present invention having a defined relationship with respect to the housing robot. To control a specific distance between the robot and the wall while the robot moving forward parallel to the wall, it is known the determining drive unit 20 can be used to calculate the moving distance and turning angle for the robot. For example, when a wheeled circular robot collides against a wall at a certain angle, the collision sensing units 50 are triggered to stop the robot. Meanwhile, the difference between the distances d1 and d2 detected by the two infrared signal transceiver units 30 arranged at one lateral side of the base 10 can be used to determine the rotating direction of the wheels, so that one of the two wheels rotates forward while the other one rotates backward for the base 10 and accordingly, the robot to turn about a middle point on the axial line of the two wheels until the specific signals separately received by the two signal transceiver units 30 have the same signal intensity. This means the robot is now oriented in a direction parallel with the wall. As can be seen from FIG. 8, an angle θ by which the robot orientates to the direction parallel with the wall can be calculated by the determining drive unit 20. Then, the robot can be caused to turn further away from the wall by a predetermined angle θ₀. In the illustrated embodiment, the angle θ₀ is 45°. Then, the robot is caused to move straight forward by a distance f, which can also be obtained by the determining drive unit 20 through a control circuit. Thereafter, the robot can be caused to turn reversely by the same angle θ₀. At this point, the robot shall be parallel to the wall. Whether the robot has become parallel to the wall can be again detected and controlled by the two signal transceiver units 30 located at one lateral side of the base 10. Since the geometrical shape of the robot is known and the spatial relationship of the sensing system with respect to the housing is predefined, the current distance between the robot and the wall can be derived from the trigonometric geometry relation. For example, in the case of a circular robot, the distance between the robot and the wall can be calculated from the following formula:

dₛ=s(sin θ)+f(sin θₒ)

where, s is the offset distance between the geometrical center of the circular robot and the rotating center about which the robot turns; θ₀ is a user-defined control parameter; θ is the angle at which the robot collides against the wall and can be calculated by the determining drive unit 20; f is the distance by which the robot moves after turning; and dₛ is the distance between the robot and the wall and can be controlled via the value of f.

Finally, the rotating speeds of the two wheels can be adjusted depending on the difference between the two distances d1, d2 detected by the two signal transceiver units 30 at the left side of the base 10, so that the robot can keep moving parallel to the wall while maintaining a specified distance from the wall. When the robot moves to a corner or any other change in the shape of the wall surface, the aforesaid successive movements of colliding, orientation, moving forward, and reorientation are repeated to re-locate the robot, so that the robot can still move parallel to the changed wall surface while maintaining the specified distance between the robot and the following wall.

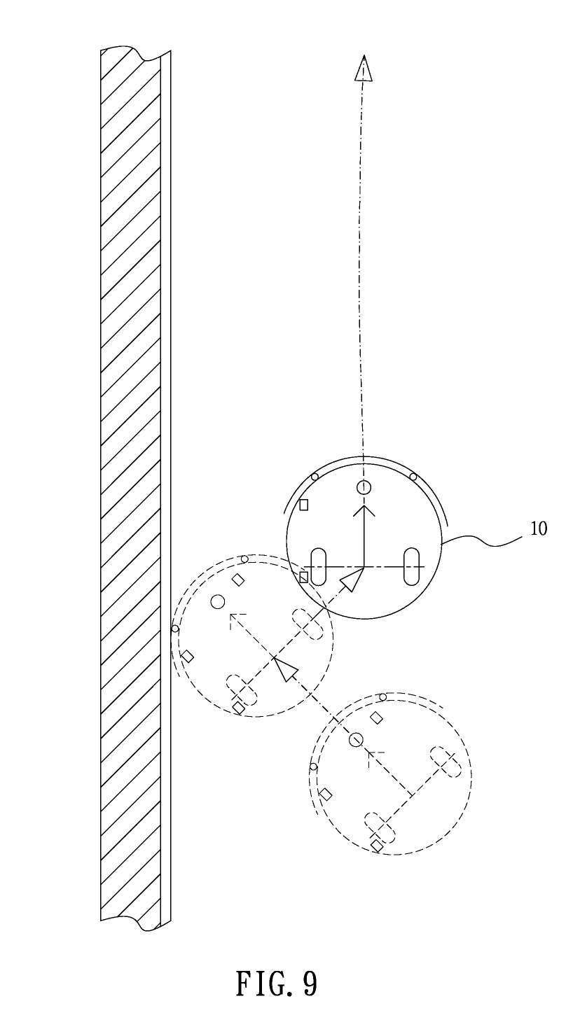

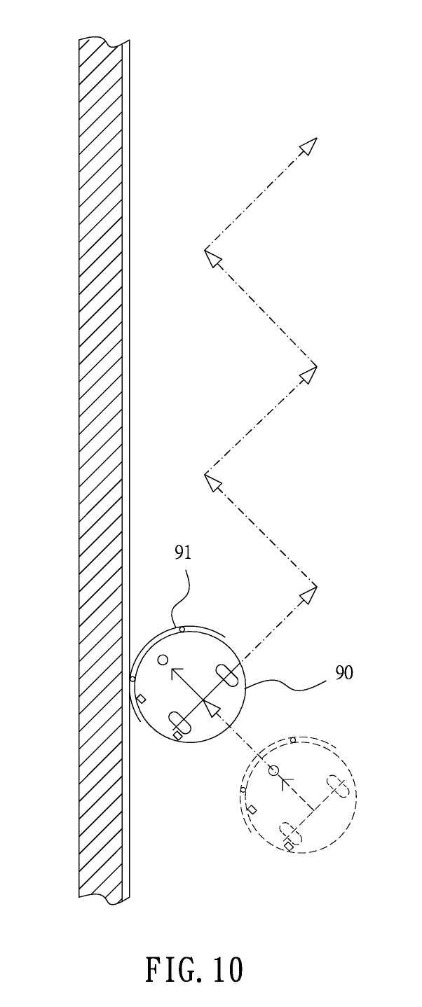

The present invention does not directly estimate the distance between the robot and the wall surface from the signal values of the two signal transceiver units 30, but uses the difference in the intensity of two detection signals to measure the parallelism between the robot and the wall and then uses the determining drive unit 20 to control the movement of the robot. In this manner, errors in the measured distance due to different surface characteristics on the obstacle can be avoided. With the above-described mechanisms, it is able to maintain a defined distance between the robot and the wall surface to largely increase the wall-following accuracy and performance of the robot. FIG. 9 shows the path along which the robot provided with the wall-following moving device of the present invention moves to finally become parallel to the wall.

In the wall-following moving device of present invention, the collision sensing units 50, the determining drive unit 20, the signal transceiver units 30, and the moving element 40 cooperate with one another, so that corresponding movement commands can be output after signal receiving, determining, and calculating procedures to exactly enable the robot to keep parallel with the wall when following the wall. Since the present invention compares the intensity of the specific signals separately received by the two signal transceiver units 30 and uses the intensity difference between the two signals as the basis for determining the required adjusting movements, it is able to avoid the problem in the prior art, which uses infrared to sense the distance between the robot and the wall, and tends to have low accuracy in determining the distance due to influence by different wall surface characteristics.

What is claimed is:

1. A wall-following moving device, comprising:
a base;
a determining drive unit being mounted on the base;
two signal transceiver units being capable of synchronously transmitting and receiving specific signals that will be reflected back from an obstacle, being arranged on the base at the same lateral side, being spaced from each other and being electrically connected to the determining drive unit for sending the received specific signals to the determining drive unit; and
a moving element being mounted to the base and electrically connected to the determining drive unit, being driven by the determining drive unit to perform various movements, such as moving forward, moving backward, turning in a curve, reorienting to a specified direction, etc.

2. The wall-following moving device as claimed in claim 1, wherein the specific signals transmitted and received by the signal transceiver units are infrared signals; and wherein the signal transceiver units are arranged into a line parallel with a moving direction of the base and have signal transmitting and receiving directions perpendicular to the moving direction of the base.

3. The wall-following moving device as claimed in claim 1, wherein the specific signals transmitted and received by the signal transceiver units are ultrasonic signals; and wherein the signal transceiver units are arranged into a line parallel with a moving direction of the base and have signal transmitting and receiving directions perpendicular to the moving direction of the base.

4. The wall-following moving device as claimed in claim 1, wherein the invention further has at least one signal transceiver unit to enhance accuracy for detecting.

5. The wall-following moving device as claimed in claim 1, further comprising multiple collision sensing units being separately arranged along the front portion of the base; and a protection bumper being further attached to the collision sensing units; and the collision sensing units being electrically connected to the determining drive unit, so as to transmit an electronic signal to the determining drive unit when the wall-following moving device collides with an obstacle.

6. The wall-following moving device as claimed in claim 1, wherein the moving element includes two wheels driven by separate motors to move; the two wheels being located at the opposite lateral sides of the base, and the motors being driven by the determining drive unit to individually control the wheels.

7. The wall-following moving device as claimed in claim 1, wherein the base is circular.
